(19) United States
(12) Patent Application Publication
(10) Pub. No.: US 2021/0212503 A1
(43) Pub. Date: Jul. 15, 2021

(54) SPLATTER CONTROL APPARATUS WITH TENSION RING AND METHOD

(71) Applicant: Alex Kheder, Anaheim, CA (US)

(72) Inventor: Alex Kheder, Anaheim, CA (US)

(21) Appl. No.: 16/737,916

(22) Filed: Jan. 9, 2020

(51) Int. Cl. A47J 36/06

(52) U.S. Cl. CPC A47J 36/06

(57) ABSTRACT

A splatter control apparatus for covering foodstuffs during cooking, having a flexible tension ring member, a frame member and replaceable disposable splatter control element. The frame is configured to cradle the ring member and the splatter control element, also is suited to rest on the top edge of any size and shape cooking vessel. The flexible ring member configured substantially to be properly held inside the inner side of the frame member securing the replaceable disposable splatter element between the ring member and the frame member during a cooking process thereby performs as a splatter control and filtration means. After use, the disposable splatter element is easily discarded creating minimal waste due to its negligible material content, averting the need for messy cleanup.

### CROSS REFERENCE TO RELATED APPLICATIONS

Provisional Patent Application No. 62/790,377, Filing Date: Jan. 9, 2019

### STATEMENT REGARDING FEDERALLY SPONSORED RESEARCH OR DEVELOPMENT

Not applicable.

### REFERENCE TO SEQUENCE LISTING

Not applicable.

### FIELD OF THE INVENTION

The present invention apparatus relates to splatter control in one common field is in the kitchen accessories, and relates particularly to a cooking splatter control covering device for cooking vessels. More specifically, this invention relates to a replaceable disposable splatter control device to be used with utensils and cookware.

### BACKGROUND OF THE INVENTION

It is commonly known that frying, searing or simmering foods on a stovetop can be a messy process, even for an experienced cook. Food liquids, oil and/or grease often splatter outside the pot, pan or other cooking utensils and onto the surrounding areas of the stove, counter tops and walls. Such splattering materials not only create unsanitary, unsightly messes on the stove, counter tops, walls and surrounding surfaces, but also produce an undue safety hazard to persons, further it create fire hazard due to grease buildup. The splattering of grease from inside a cooking utensil can not only cause severe burns on people, but also increases the likelihood of kitchen grease fires. Statistics in 2017 reveal that nearly 5,000,000 cooking fires occur annually in the home. Of these fires, grease fires are the most dangerous and are responsible for 1 in every 5 home fire deaths.

In light of these challenges, many devices currently available to control splattering include: metal covers or mesh covers which are placed over the vessel or food item being prepared; plastic covers and absorbent papers which are placed over or around foods being prepared, aluminum foil and parchment paper placed over casseroles and roasting pans in ovens. None of these devices, however, combine all the attributes of being disposable, universally adaptable to all of the major cooking settings and capable of maintaining a cooking environment suitable for all cooking types, and yet simple to use during cooking. Although capable of preventing splatter of cooking liquids still have several disadvantages. Many are designed to fit only a specific size and shape of a given pot or pan, many with the challenge of cleaning the screen, others with the difficulty of exchanging the paper towel as limiting to the scope of their versatility. Finally, they are relatively expensive, and can be difficult to clean.

An example of such splatter guard devices can be found in:

U.S. Pat. Nos. 3,809,281, 5,992,675, U.S. Pat. Nos. 6,056,146, 7,326,895, D302,637, D494,427 and D567,597 all teach the use of splatter guards which utilize wire mesh to prevent splatter while still allowing steam and other cooking vapors to escape, rendering an environment suitable for frying, searing and sautéing. However, they are known to easily get damaged, costly and they are not disposable. Furthermore, their mesh design makes them difficult to clean. U.S. Pat. No. 2,999,559 teaches the use of a disposable disc made out of fibrous material in conjunction with a metal ring, which rests on the periphery of the cooking vessel. Although the top disc is disposable, the metal ring is bulky, not easy to store and still requires cleaning. U.S. Pat. No. 2,686,608 teaches the use of a cylindrical guard made out of disposable paper that sits inside a frying or other vessel and includes vents to encourage air circulation. However, the configuration of this device is such that it is open at the top and does not entirely prevent the splatter of grease and liquids. Also, this configuration lacks a handle for easy positioning and makes turning or other manipulations of food in the cooking vessel difficult.

U.S. Pat. No. 9,655,471 B2 is a disposable non-absorbent rigid covering, although this design is disposable it is not practical to operate and use, causes moisture condensation and prohibitively high cost. U.S. Pat. No. 9,492,029 B2 is a tongue like devise that clamps onto a paper as a splatter guard. DE 102010001163 is a circular frame that clamps onto a paper, although this uses a paper produce, however the many moving parts and need for fastening means render the design to collect food remains and grease splatter, also complicated to replace the paper while cooking. Further with many moving parts results in high cost to manufacture.

Many of these existing devices are known to have a circular frame into which a paper can be clamped in. However, the action to insert of the paper is cumbersome, time consuming and unsafe during cooking, also the manufacturing process is complex and costly.

Clearly there is a need for a tried and tested splatter control method that combines the convenience of being disposable, affordable, simple and safe to use, eliminate splatter, reduce cooking odor, prevent grease fires, prevent injuries, being generally heat and flame-resistant, can be permeable to offer preferred cooking conditions and is versatile enough to be used with any common cooking methods and vessels.

### SUMMARY OF THE INVENTION

The principle aim of the invention herein is to provide a splatter control apparatus that prevents splatter of grease and liquids during cooking operations that is versatile enough to be used with virtually any cooking vessel and with many cooking methods.

Another aim of the invention herein is to provide a splatter control apparatus that also provides the advantages of being efficient, practical, economical and easy to handle with a replaceable element that can have a activated carbon feature that absorbs odors, be absorbent or non-absorbent, porous or non porous, paper related, fabric related, silicon, mesh screen material or a combination of multi materials thereof.

These and other objects are addressed by the present invention, directed to a splatter control apparatus comprising a flexible tension element member (a ring) configured to opportunely secure into a frame member, a frame member suitable to rest on top edge of a cooking vessel with an splatter control element member that can be secured between the tension ring member and the frame member thereby controlling the moisture dripping and oil splatter. This new novel invention is in dire need to prevent personal injuries, prevent fire hazards, protect and maintain sanitary clean stove and surroundings, and also control the air quality from cooking odors.

More particularly, the present invention is directed to a splatter control apparatus comprising a flexible tension ring member to be secured into the inner side of a frame member, a frame member with the inner side of the frame member configured to cradle a flexible tension ring member, a flat sheet element member is secured between the tension ring member and the frame member, a handle member is coupled to the frame as needed, support elements added to the bottom edge of the frame member to permit it to rest on top of various shape and size vessels.

In one preferred embodiment, a flexible tension ring member configured to be secured snuggly and secured into the inner side of a frame member generally a circular element (such as a lid for cooking vessel), a replaceable flat sheet member suited to be provisionally secured between the frame member and the flexible tension ring member. The ring member is of a flexible tension character when compressed it builds tension, upon being decompressed it restore its tension and can be secured into the inner side of the frame member, and hence the flat sheet member is secured in between the ring and the frame. Plurality of protrusions extend of the outer edge of the ring member for better security of the ring and the sheet into the frame, also protruding nipples or the like extend properly and proximately of predetermined points of the edges of the ring member to enable manipulating it to be placed it in and out of the frame member.

In another embodiment, a flexible tension ring member is being enveloped by a sleeve of disposable absorbent material configured to be manipulated to be secured into the inner side of a frame of a lid (cover) for a cooking vessel. The absorbent material performs as a splatter control. Further in another embodiment a disposable flexible tension ring member enveloped by a sleeve of disposable absorbent material configured to be manipulated to be secured into the inner side of a frame of a lid (cover) for a cooking vessel. The combination of disposable ring and disposable sleeve member perform as a complete disposable splatter apparatus. Such economically convenient device can ideally serve personal, commercial and travel need.

In another preferred embodiment, having a flexible tension ring member, a frame member having varied dimensions, a replaceable disposable flat sheet member, the inner side of the frame configured to cradle the flexible tension ring, the flexible ring member configured to compress to secure into the inner side of the frame member, the ring member tension secure the flat sheet into the inner side of the frame to work as a splatter guard. The ring member is opportunely coupled to the frame member to swing about the coupling in and out of the frame member; the ring is compressed to pull out of the frame, a flat sheet member is placed between the ring and the frame, then the ring is pushed over the flat sheet into the frame and securely decompressed inside the frame. Plurality of protrusions may extend from the outer edge of the ring member to create stronger gripping function over the replaceable flat sheet, also protruding means or the like properly and proximately extend of the ring member to manipulate the compression of the ring member to manipulate in and out of the inner side of the frame member. Supporting elements (ribs) are proximately coupled to the bottom edge of the frame member to rest on top of various size cooking vessels. The flat sheet member may be of one or combined of materials such as paper related, fabric related, silicon related, bamboo related, porous material, non porous material, screen mesh or the like. The flat sheet member can easily be disposed of after cooking therefore eliminating the cumbersome need to clean this apparatus. The splatter control apparatus can be temporarily or permanently coupled (by a common coupling means) to a rim of a vessel as a substitution of or a complement to a handle to manipulate lifting and moving the apparatus.

In another embodiment, volume structure (dome, pyramid or the like) can be added on top of the frame member and created and provide extra cooking space for the splatter and moisture build up during cooking.

The flat sheet and sleeve members can be configured to have carbon activated character attributes or similar features that help absorb cooking odors.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings, in which:

FIG. 1—is an apparatus according to a first embodiment,

FIG. 1A a perspective top view of a flexible member of a first embodiment,

FIG. 1B a perspective of a flexible member and a sleeve member in isometric and top views,

FIG. 1C a perspective of a flexible member and a sleeve member inside a frame member,

FIG. 1D a perspective member of a flexible member securing a flat sheet inside a frame member,

FIG. 1E a view of a flexible member design options,

FIG. 2—is a perspective of an apparatus according to a second embodiment in isometric, side and top views, and

FIG. 3—is a perspective of an apparatus according to a third embodiment in isometric, side and top views.

### DESCRIPTION OF INVENTION

The invention herein relates to a cooking utensil (apparatus) with replaceable disposable element that can be universally utilized in almost any cooking method to eliminate the challenge caused by splattering of grease and cooking liquids. In its broadest form, the utensil is made of a flexible tension member (a ring like), a frame suited to cradle the flexible tension member and a splatter control means (flat sheet or sleeve form) which can be placed between the flexible ring member and the frame member. A utensil that is versatile enough be used in a multitude of different cooking environments and can be dimensioned so as to fit a wide variety of cooking vessel shapes and sizes. The utensil may include a handle for lifting and repositioning of the utensil, and may include supporting means (ribs) in such a way to rest on the rim of various size vessels. When an absorbent, porous element used, as the splatter control, and when the utensil is rested directly on top a cooking vessel, this results in minimal oil and grease splatter also enables cooking in a manner similar to that in which it would occur without a cover, rendering it suitable for frying, searing and sautéing operations.

The splatter control flat sheet and sleeve member can be made from a material that is paper related, fabric related, silicon related, bamboo related, porous or non-porous, screen mesh or a multi material combination thereof for variable embodiments.

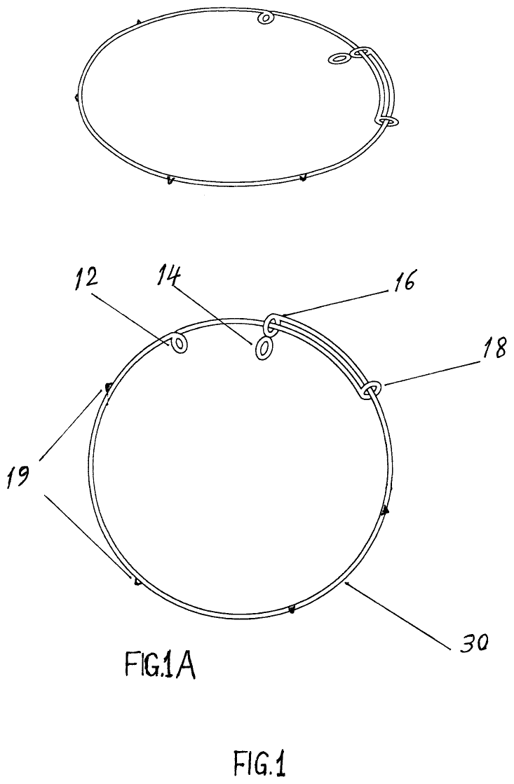

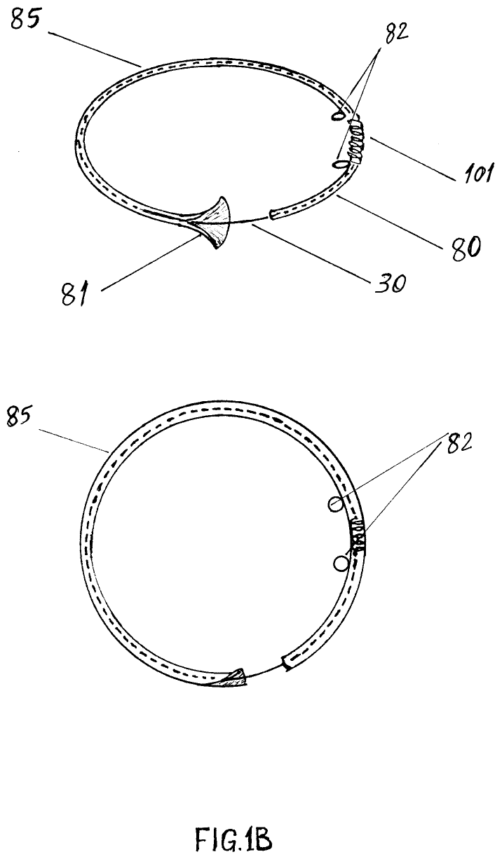

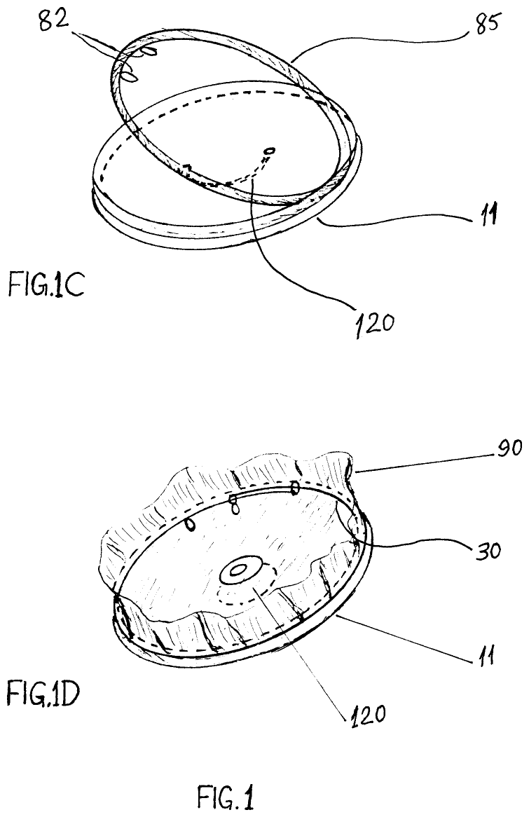

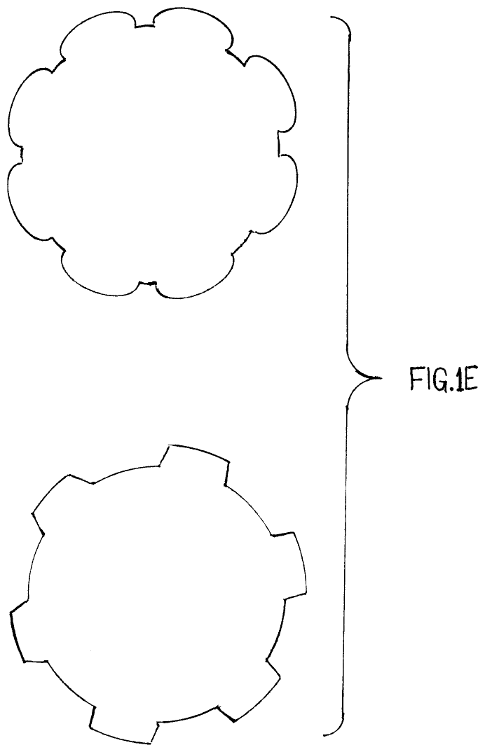

A first embodiment of the splatter control Apparatus is illustrated in FIG. 1, for purpose of illustration, Top view in FIG. 1A shows the present invention is preferentially embodied in an approximately circular shape tension ring 30, comprises a structure of a flexible tension type material with ends 16 and 18 opportunely proximately flexible to operate with two protruding means 12 and 14 (knobs or the like) positioned at a predetermined proximate location near the ends, 14 is proximate to the end 16 and 12 is proximate to the end 18, when 12 and 14 are compressed closer, relative to one another, the ring member 30 builds up tension, thereafter releasing the knobs 12 and 14 decompress the built up tension in the flexible ring. The flexible ring is made to be secured into the inner side of a frame of a lid or cover 11 as shown in FIG. 1D. A flat sheet member 90 (splatter control means) shown in FIG. 1D can be placed between the tension ring member 30 and the inner side of the frame member of a lid 11, where generally the frame member 11 can be a lid for a cooking vessel. A handle used for lifting the lid shown as 120 in FIG. 1D. The tension ring member 30 made to secure the flat sheet member 90 inside the frame member 11 without the need for clips, screws, bolts or any attaching mechanism. The ring tension compression motion of 12 and 14 and subsequently the ends 16 and 18, relative to one another, shown in FIG. 1A is the only action required in order to exchange the flat sheet member 90 after use. FIG. 1D shows the flat sheet member 90 secured between the ring member 30 and the frame member 11 of a lid, where the flat sheet member 90 being made of an absorbent porous material therefore acts as splatter control means inside the lid to prevent grease and oil splatter, also prevents condensed moisture on undersurface of the lid 11 from dripping back over the hot oil or hot pan and hence eliminating splatter and keeping the integrity and quality of cooked food. For safer handling 12 and 14 can be covered with protective insulating material as required. The flat sheet 90 is easily discarded creating minimal waste and replaced quickly with a new flat sheet member after the cooking process. When the ring member 30 with the flat sheet 90 secured therein into a lid 11 can then be properly placed on top edge of a appropriate cooking vessel. Plurality of protrusions 19 (claw like) extend of the outer edge of the ring member 30 at predetermined positions to improve securing the ring 30 and the flat sheet 90 into the inner side of a frame member 40. In various designs, and as it may be required, the protruding elements 12 and 14 may extend properly and proximately at predetermined position around the ends of a ring member 30 to manipulate its compression motion. Also, the ring member 30 can be made with protruding means 12 and 14 as the ends of the ring member 30, to substitute for the overlapping mechanism formed by 16 and 18, the modification of 12 and 14 provides another compression mechanism design and method of manufacturing. The tension ring member can vary is shape, size and design with no limitations, two examples are shown in FIG. 1E.

FIG. 1B shows an apparatus 85 comprising a flexible tension ring member 30 being enveloped by a sleeve or the like of disposable absorbent means 80, the apparatus 85 configured to be manipulated to be secured into the inner side of a frame of a lid 11 for a cooking vessel FIG. 1C. The ring member comprises a compression mechanism 101, the sleeve member 80 offers a side opening 81 or the like that allow the sleeve 80 to slip over the ring member 30 and create an envelope effect, and hence this ring 30 sleeve 80 combination means form a device 85 being an absorbing splatter control means when secured inside a lid 11 for a vessel FIG. 1C. Further, the flexible ring member 30 can be made of a disposable flexible tension material with all other elements and features exactly identical, The combination of a disposable ring member 30 and disposable sleeve member 80 perform as disposable splatter device 85 that eliminates the need to replace any parts after cooking, this device can ideally serve personal, commercial, indoor or outdoor settings. The physical state of the flexible ring member 30 can be elastically adaptable opportunely and proximately enough to be placed properly into the inner side of a frame of a lid 11 for a vessel, one possible attached means 82 can extend of the apparatus 85 to easily manage placing the apparatus in and out of a lid is shown in FIG. 1C.

To place the apparatus 85 into the lid member 11, the ring is compressed by the mechanism 101 utilizing the means 82 FIG. 1B and FIG. 1C, the compression released after placing the apparatus 85 inside the lid 11, thereafter the compression of the ring member 30 will secure the apparatus 85 inside the lid 11 during the cooking process, subsequently the moisture and splatter produced from cooked foods which usually is condensed on the undersurface of the lid 11 will gradually slither of the curved surface of the lid 11 to its perimeter where the absorbent sleeve 80 of the apparatus 85 is placed, therefore the disposable apparatus 85 soaks up the grease and moisture mixture and stop any from dripping back over the frying or cooking foods FIG. 1C. The disposable ring member can be made of elastic material means adaptable to fit into a lid through any familiar compression mechanism, without limitations, that is achieved through bending, twisting, spiraling, squeezing, overlapping, o-ring compression, or the like.

This apparatus can be made in variable design options, one option which comprises a tension ring member 30 made of sustainable material means to be reused indefinitely such as metal related, plastic related, silicon related, wood related or the like along with a replaceable disposable sleeve member 80. a second option is made with a tension ring member 30 of disposable material along with a disposable sleeve member 80 to create a complete disposable apparatus 85 as shown in FIG. 1B. Both options provide a disposable splatter control element that is environmentally friendly and is ideal for use in the travel, hospitality, home or commercial settings with minimal waste. The ring member 30 can be made from a proper material such as paper related, wood related, bamboo related, metal related, plastic related, silicon related or the like. The apparatus 85 offer a friendly convenient affordable method of splatter control to maintain clean area during cooking while creating the quality foods desired, other features include convenient transport and storage. This novel disposable sleeve ring apparatus 85 can be produced in individual predetermined size ring members made for specific lid measurements, or produced in bulk format like a role or a stack format and can be dispensed in predetermined pre-scored segments into the desired size to conform to the lid size being used, the bulk format will provide new possibilities for use with any size and shape lid.

It would also be obvious to anyone skilled in the art that materials used can vary and be configured accordingly for any specific need or use, also the device can be fashioned into a variety of shapes and sizes so as to conform to the shape and size best suited for use with specific cooking vessels without departing from the scope of the invention.

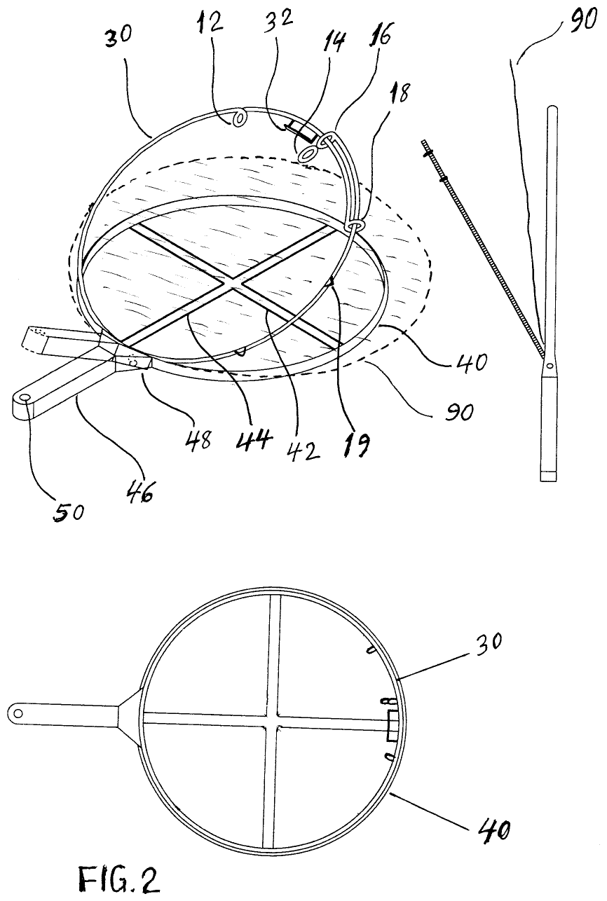

FIG. 2 illustrates a second embodiment of a splatter control apparatus. The splatter control apparatus according to the second embodiment comprises a flexible tension ring member 30, a frame member 40 with inner side designed to cradle the ring member 30, the ring member 30 is opportunely coupled to the frame member 40 to swing in and out of the frame 40, the ring 30 can compress substantially to manipulate to be secured inside the frame member 40, a flat sheet member 90 is being placed and held between the ring 30 and the frame 40, where the tension ring 30 secures the flat sheet member 90 properly into the frame 40, the ring 30 is generally made of a flexible tension capable material, protruding means 19 (claws or the like) extend from the ring 30 for extra security while holding the ring member 30 over the flat sheet member 90 into the frame member 40, the ends 16 and 18 are opportunely coordinated to compress and decompress to manipulate the ring 30 in position into the frame member 40. Protruding means 12 and 14 (knobs or the like) extend form the ring 30 to manage the compression of the ends 16 and 18 of the ring member 30. In the compression mechanism, 14 is proximate to the end 16 and 12 is proximate to the end 18, as 12 and 14 compress closer, relative to one another, the ring 30 is manipulated slightly smaller to easily slip in and out of the frame member 40, the released compressed ring 30 return to its original state and subsequently secured properly inside the frame 40 and hence securing the flat sheet member 90 in place, the replaceable disposable flat sheet 90 eliminates the need for any cleaning of this splatter control apparatus and subsequently any cleaning for the surrounding cooking area, more importantly the apparatus can protect from fire hazards and splatter burns and can be generally heat and flame-resistant. The knobs 12 and 14 can be coated with a protective insulating material. Further, the ends 16 and 18 of the ring member are configured to be part of a coupling mechanism to attach to the frame member 40, where the ends situated in a groove like, slot like or track like space on the frame member which will permit the ring ends to shift and slide sideways to compress and decompress the ring member 30 to be manipulated in and out of the frame member 40. The compression mechanism of the ring 30 may employ variable designs to achieve similar results without departing from the scope of the invention. Supporting means shown as 42 and 44 added to the frame 40 at proximate predetermined position enables the frame to rest on the top edge of variable size and shape cooking vessels where the number of ribs is determined by need. This invention can utilize a proper handle design 46 coupled to the frame for easy handling, the handle 46 can be riveted, hinged or detachable by a proper coupling means. Appropriately, there is an eyelet 50 on the handle 46 for the hanging and storage of the splatter device on a hook or the like; it is located on the rear end of the handle 46 however this example does not limit other hanging mechanism or storage options. A lift lever 32 or the like extend of the ring member 30 as needed. This splatter control device with its versatility can be modified to be temporarily or permanently coupled to the top edge of a vessel as a substitution of or a complement to the use of a handle to manipulate lifting and moving the apparatus.

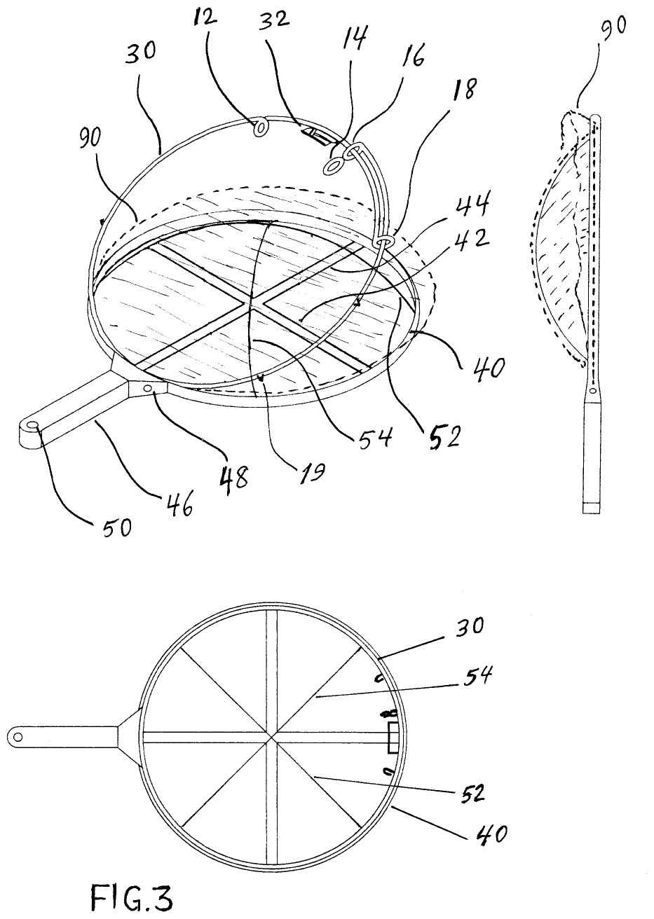

A third embodiment of the splatter control apparatus illustrated in FIG. 3. a splatter control apparatus according to this embodiment is essentially identical to the splatter control apparatus according to the second embodiment, except for the added elements 52 and 54 or similar structure to create an added volume space on top of the frame member 40 represented in FIG. 3 this added structure will create extra cooking space volume for the splatter and moisture produced during cooking, with all other elements of the second embodiment are still applicable and essentially identical. Before the cooking process a flat sheet member 90 can be placed over the frame member 40 and the structure created by 52 and 54 and thereafter the ring member 30 closing over the flat sheet 90 and is secured into place inside the frame member 40 FIG. 3. This embodiment can provide a significant safety factor when the cooking liquid or oil is to a high level closer to the rim in the vessel. All other features and benefits of the apparatus indicated in the second embodiment are still valid and present.

This invention concept can easily be modified to accommodate various other applications in the medical, industrial and manufacturing domains.

To demonstrate the effectiveness of the herein described invention, a disposable splatter paper sheet was tested with both the first and the second embodiment employing a flat sheet and a sleeve material, Fatty lamp ribs were then placed into a hot standard frying pan so that the fatty ribs were lying flat. The splatter sheet was secured inside a lid according to FIG. 1D of a frying pan and placed over the ribs so that the lid was sitting on top of the ribs inside the pan. The lamb was allowed to sear at a high temperature for several minutes during which time the splatter paper sheet very effectively prevented any grease from leaving the frying pan yet allowed water vapor to escape and trap on the undersurface of the lid without any moisture dripping over the lamb, as evidenced by steam condensed and being visible above the secured flat sheet and under the glass of the lid and no water buildup in the frying pan, as can be easily observed when searing meat with the aid of a solid, impermeable cover, the lid with the splatter flat sheet was then lifted so that the lamb could be turned. Although sitting directly on top of the searing meat, the splatter sheet retained its structural integrity for 40 minutes of continuous use without any moisture drips over the meat. After several repetitions of removing and repositioning the lid with the splatter sheet to allow turning, the meat was fully cooked and well browned to a pleasing level of caramelized taste, further demonstrating that the splatter sheet was effective at allowing the escape of moisture so as to allow a relatively high cooking temperature and an effective cooking environment for frying. After the cooking process was complete, the splatter sheet was disposed of and clean up was simplified by the fact that minimal grease and other cooking liquids had been able to splatter onto the stovetop. Similar results were achieved as in FIG. 1C using the sleeve member 85 inside the lid 11, especially upon lifting the lid during cooking all the accumulated moisture were stopped by the apparatus 85 in FIG. 1C. The same demonstration was performed using a flat sheet of paper type with the second embodiment demonstrated in FIG. 2. The demonstration of both embodiments was repeated with searing and deep frying of different foods. The performance of the splatter control apparatus stopped most grease splatter and allowed all the moisture to escape while the moistened flat sheet performed in absorbing some cooking odor.

It is understood that the above-described embodiments are only illustrative of the application of the principles of the present invention. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Although the figures illustrate few embodiments with circular shaped apparatus, one skilled in the art would appreciate that the apparatus may be shaped differently to conform to different sized and shaped vessels, according to various embodiments.

It is also envisioned that the flat sheet member 90 may be of variable materials or combination of transparent, fully and/or partially opaque, porous, non-porous, mesh screen material according to various embodiments. It is expected that there could be numerous variations of the design of this invention and may vary in shape, width, length, size, diameter, thickness, design, etc., according to alternative embodiments. It is envisioned that the components of the device may be constructed of a variety of available proper materials with no limitations, such as metal, paper, fabric, fiber, wood, bamboo, silicon, plastic, polymer, or a combination thereof. while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, motion mechanism, usage, function and manner of operation, assembly and use may be made, without departing from the principles and concepts of the invention as set forth in the claims. It should be noted, that it is unprecedented to implement the use of spring force in the manner in which claimed as part of kitchen accessories.

I claim:

1. A splatter control apparatus comprising:
a flexible tension member configured to be manipulated to be secured inside a frame of a lid for a cooking vessel,
a flat sheet means is replaceable disposable that can be secured between said flexible tension member and the inner side of the frame of a lid for a cooking vessel,

2. A splatter control apparatus as in claim 1, wherein said flexible member and said frame member are of corresponding geometrical shape and size.

3. A splatter control apparatus as in claim 1, wherein said flexible member is a ring shape secured in said frame member by tension displacement.

4. A splatter control apparatus as in claim 1, wherein said flexible member being made from an elastic tension capable material and configured to compress against own resting force.

5. The splatter control apparatus as in claim 1, wherein said flat sheet means being formed from the group consisting of one or a combination thereof vapor-permeable material, porous material, non porous material, transparent material, opaque material, fabric material, paper material, a cellulose cloth, silicon, plastic, bamboo, or screen mesh.

6. A splatter control apparatus as in claim 1, wherein said flexible member is configured to be enveloped by a sleeve of disposable absorbent material.

7. The use of the apparatus according to claim 1 for covering cooking vessels used to prepare foods in stovetop, oven or counter-top cooking operations.

8. A splatter control apparatus comprising:
a flexible tension member configured to be manipulated to be placed into a frame of a lid for a cooking vessel,
a disposable absorbent sleeve means configured to envelop said flexible tension member, where said flexible member that is enveloped by said disposable absorbent sleeve member thereby being secured into the frame of a lid to form a splatter control apparatus that can absorb grease and moisture splatter.

9. A splatter control apparatus as in claim 8, wherein said flexible tension member and said sleeve member are being formed of disposable material.

10. A splatter control apparatus comprising:
a flexible tension member configured to be manipulated to be secured into a frame member,
a frame member having a inner side configured to cradle a flexible tension member,
a flat sheet means being replaceable disposable and can be provisionally secured between said flexible tension member and the inner side of said frame member, thereby stopping grease splatter and controlling cooking moisture.

11. A splatter control apparatus as in claim 10, wherein said flexible tension member being a ring shape coupled to said frame to swing angularly out and into the frame member.

12. A splatter control apparatus as in claim 10, wherein said flexible member configured to compress against own resting force and decompress to be secured into said frame member.

13. A splatter control apparatus as in claim 10, wherein the flexible member comprises protruding claws to better secure it into said frame member.

14. A splatter control apparatus as in claim 10, wherein the perimeter of said frame member has a size and shape corresponding to suitably cradle said flexible member.

15. A splatter control apparatus as in claim 10, wherein the ring and frame members are of corresponding shape, size and configured to accommodate variable shape, size and form vessels.

16. A splatter control apparatus as in claim 9, wherein said frame member configured of a variable shape and measurement.

17. A splatter control apparatus as in claim 10, further comprising a proper handle being detachable, riveted or coupled to the frame member.

18. A method for using a splatter control apparatus to prevent splattering of liquids from a cooking vessel, the method comprising:
Providing a splatter control apparatus comprising:
a tension ring member with two operable points configured to compress and decompress, the two points configured to be pressed together relative to one another in a closing direction, and a frame member configured to cradle the tension ring member, when the ring operable points are pressed together relative to one another in a closing direction the ring shrinks slightly to be manipulated into place within the frame member;
pressing the two points of the tension ring closer together will slightly compress the ring;
holding the two points in the pressed together position;
inserting a flat sheet means member between the ring member and the inner side of said frame member;
releasing the two points from the pressed-together position; and
hence the flat sheet member is secured between the ring member and the frame member, wherein the flat sheet member operate as splatter control apparatus that covers an opening of a cooking vessel thereby preventing splattering of liquids from the cooking vessel.
When a sleeve member is employed,
a side opening of the sleeve is spread wider while slipping the sleeve over the ring member, and thereafter the sleeve opening is restored to its original form enveloping the ring member;
thereby the sleeve ring combination is secured into a lid for a cooking vessel to absorb splatter and moisture.
